(19) United States
(12) Patent Application Publication
(10) Pub. No.: US 2024/0359946 A1
(43) Pub. Date: Oct. 31, 2024

(54) SOLUTION FOR DETECTING AN ENTITY OF AN ELEVATOR SYSTEM

(71) Applicant: KONE Corporation, Helsinki (FI)

(72) Inventor: Gabriela ROIVAINEN, HELSINKI (FI)

(73) Assignee: KONE Corporation, Helsinki (FI)

(21) Appl. No.: 18/768,305

(22) Filed: Jul. 10, 2024

Related U.S. Application Data
(63) Continuation of application No. PCT/EP2022/054973, filed on Mar. 18, 2022.

(51) Int. Cl. B66B 5/00

(52) U.S. Cl. CPC B66B 5/0025

(57) ABSTRACT

A solution for detecting an entity of an elevator system based on a representation generated from measurement data is provided. The solution includes generating the representation in a frequency domain descriptive of a vibration experienced by the elevator car; determining if the representation includes a number of portions corresponding to reference data; and setting, in accordance with a determination, a detection result to express one of the following: i) an entity corresponding to a vibrational fingerprint of the reference data is present in the elevator system, ii) an entity corresponding to a vibrational fingerprint of the reference data is absent in the elevator system.

### TECHNICAL FIELD

The invention concerns in general the technical field of elevators.

### BACKGROUND

Elevators are implemented from a plurality of entities, such as components, which are selected during the designing phase. The entities of an elevator system are selected so that they, either alone or in combination with one or more other entities, generate an effect enabling the elevator system to meet its requirements in its intended use. As a result, a list of materials, or so-called bill-of-materials, BOM, is generated which contains the entities from which the elevator system is built to.

The problem with the above described way of generating the list is that it is prone to errors. This is partly because it may turn out that some listed entities are changed during the construction phase, but such an information is not updated into the list of materials. Moreover, since the elevators are continuously maintained and repaired, and it may occur that some original entities of the elevator, such as one or more components in the elevator shaft, are changed to some other entities, but not to original ones, and such information does not end up to the list of materials. A still further problem is that even if the list of materials exists and it is up-to-date there may occur deviation in the installation of new components so that replaced components are not installed in the same position e.g. in the shaft as the original ones. This, in turn, may cause disturbance, such as vibration experienced by the passengers during the travel.

From a manufacturer's point of view it would be advantageous to keep on track on the entities included to elevator systems during its lifetime and on the installation setup in general. On the other hand, such a task is challenging to realize when there is a vast amount of elevators to follow up. Hence, there is a need to introduce solutions which improve the situation at least in part to keep on track on at least some aspects of an installation of the elevator system during its lifetime, and which solutions may even be configured to generate information for further use.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a computer-implemented method, an apparatus, a computer program, and a system for detecting an entity of an elevator system.

The objects of the invention are reached by a computer-implemented method, an apparatus, a computer program, and a system as defined by the respective independent claims.

According to a first aspect, a computer-implemented method for detecting an entity of an elevator system based on data in a representation generated from measurement data gathered over a travel of an elevator car is provided, the method comprising:
generating the representation in a frequency domain descriptive of a vibration experienced by the elevator car during the travel of the elevator car,
determining if the representation comprises a number of portions corresponding to reference data, the reference data defining a number of vibrational fingerprints generable by a number of entities of the elevator system,
setting, in accordance with a determination, a detection result to express one of the following: i) an entity corresponding to a vibrational fingerprint of the reference data is present in the elevator system, ii) an entity corresponding to a vibrational fingerprint of the reference data is absent in the elevator system.

For example, the number of vibrational fingerprints of the reference data may be formed in at least one of the following manner: by simulating an operation of a number of elevator systems, by identifying the number of vibrational fingerprints of the reference data from representations in a frequency domain generated from history data collected from a number of elevator systems.

The determining if the representation comprises the number of portions corresponding to the reference data may e.g. be performed on a basis of a frequency range and amplitude values of frequencies in the frequency range.

Moreover, the generation of the representation in the frequency domain may be performed based on the measurement data descriptive of a travel of an elevator car at a constant speed.

The measurement data may be received from at least one sensor configured to measure vibration experienced by the elevator car.

Still further, the representation in the frequency domain may be generated in a form of spectrogram.

The method my further comprise:
generate data record associating the entity detected to be present in the elevator system with data indicative of a position of the respective entity, store the data record to data storage.

In some examples, at least the determining if the representation comprises the number of portions corresponding to reference data may be performed with a machine-learning model, the machine-learning model being trained with the reference data to perform the determining.

According to a second aspect, an apparatus for detecting an entity of an elevator system based on data in a representation generated from measurement data gathered over a travel of an elevator car is provided, the apparatus configured to:
generate the representation in a frequency domain descriptive of a vibration experienced by the elevator car during the travel of the elevator car,
determine if the representation comprises a number of portions corresponding to reference data, the reference data defining a number of vibrational fingerprints generable by a number of entities of the elevator system,
set, in accordance with a determination, a detection result to express one of the following: i) an entity corresponding to a vibrational fingerprint of the reference data is present in the elevator system, ii) an entity corresponding to a vibrational fingerprint of the reference data is absent in the elevator system.

The apparatus may be configured to form the number of vibrational fingerprints of the reference data in at least one of the following manner: by simulating an operation of a number of elevator systems, by identifying the number of vibrational fingerprints of the reference data from representations in a frequency domain generated from history data collected from a number of elevator systems.

The apparatus may also be configured to perform the determining if the representation comprises the number of portions corresponding to the reference data on a basis of a frequency range and amplitude values of frequencies in the frequency range.

For example, the apparatus may be configured to perform the generation of the representation in the frequency domain based on the measurement data descriptive of a travel of an elevator car at a constant speed.

Moreover, the apparatus may be configured to receive the measurement data from at least one sensor configured to measure vibration experienced by the elevator car.

The apparatus may be configured to generate the representation in the frequency domain in a form of spectrogram.

The apparatus may further be configured to:
generate data record associating the entity detected to be present in the elevator system with data indicative of a position of the respective entity,
store the data record to data storage.

Still further, the apparatus may be configured to perform at least the determining if the representation comprises the number of portions corresponding to reference data with a machine-learning model, the machine-learning model being trained with the reference data to perform the determining.

According to some examples, the apparatus may be implemented with one or more computing devices.

According to a third aspect, a computer program is provided, the computer program comprising computer readable program code configured to cause performing of the method according to the first aspect as defined above when the computer readable program code is run on one or more computing apparatuses.

According to a fourth aspect, a system comprising an elevator system and a computing system communicatively connected to each other is provided, the computing system comprises an apparatus according to the second aspect as defined above.

Furthermore, the elevator system may comprise at least one sensor configured to generate measurement data descriptive of a vibration of an elevator car experienced during a travel of the elevator car.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically a system configurable to implement the present invention according to an example.

FIG. 2 illustrates schematically a method according to an example.

FIGS. 3A-3C illustrate schematically examples of representations of data according to examples.

FIG. 4 illustrates schematically further aspects relating to the representations according to an example.

FIG. 5 illustrates schematically a computing unit according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

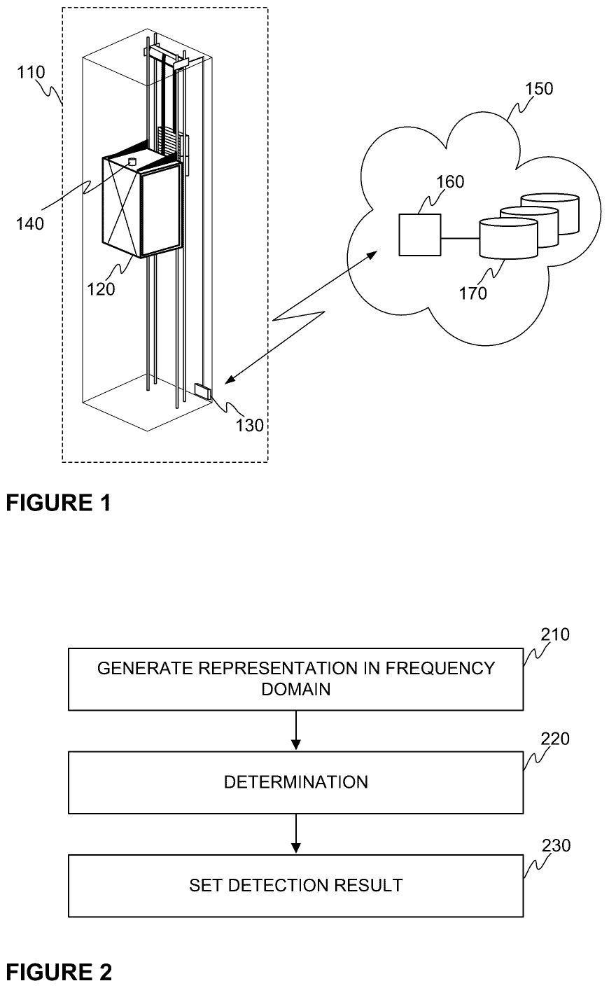

FIG. 1 illustrates schematically a system configurable to implement the present invention according to an example embodiment. The system comprises an elevator system 110 and a computing system 150 communicatively connected to each other by applying any known communication technology. The communication technology may be implemented in a wireless or in a wired manner, or in any combination of these two. The elevator system 110 residing in a building, or in any corresponding premises such as in a ship, may comprise at least one elevator comprising all necessary devices and entities to enable a travel of an elevator car 120 of the elevator system 110 in a shaft into which the elevator system 110 is implemented to. The elevator system 110 comprises an elevator controller 130 configured to control an operation of the elevator system 110 at least in part. In accordance with the present invention the elevator system 110 is equipped with a measurement system for generating measurement data for the purpose of the present invention. In accordance with an example embodiment the measurement system may correspond to a sensor 140, such as an accelerometer, to generate measurement data descriptive of a vibration experienced by the elevator car 120 during a travel of the elevator car 120. In accordance with an embodiment shown in FIG. 1 the measurement data may be transmitted to the computing system 150 implemented remotely to the elevator system 110, such as in a cloud computing environment. Herein, the processing system 150 may be implemented in a data centre configured to provide services to one or more elevator systems 110 in a manner as is described in the forthcoming description. For sake of clarity, it is worthwhile to mention that the computing system 150 may also be implemented locally in the same space as the elevator system 110, or in any combination of a local and a remote computing. The processing system 150 may e.g. comprise one or more computing units 160 as well as one or more data storages 170.

An operating principle of the system as schematically illustrated in FIG. 1 on a high level is that the elevator system is operated in a manner that generates measurement data which is transmitted to the computing system 150 for processing the data in a manner as is described in the forthcoming description.

The measurement data obtained from the elevator system 110 is advantageously such which represents its operation in a required manner over an operational cycle of the elevator wherein the operational cycle may refer to a travel of the elevator car 120 in the elevator shaft. The travel may correspond to a travel over a whole length of the travel path, i.e. the length of the shaft defined e.g. by the ground floor and the top floor, or any sub-section between the two extreme ends. For the purpose of the present invention the measurement data collected during the travel of the elevator car 120 is advantageously such that it represents vibrations experienced by the elevator car 120 during the travel. The measurement system for collecting the vibrational information of the elevator car 120 may be arranged so that at least one applicable sensor 140 is associated to the elevator car 120, such as by mounting the at least one sensor on a roof of the elevator car 120. The applicable sensor may be an accelerometer 140, or a plurality of accelerometers, or any other type of sensor configured to generate measurement data on the vibration of the elevator car 120. An example of another type of sensor may be a proximity sensor arranged to measure a distance between two entities wherein the distance changes due to the experienced vibration. Advantageously the implementation is such that the sensor 140, or the plurality of sensors 140, enable a measurement of the acceleration, comprising also deceleration, 3-dimensionally so as to generate comprehensive data of the vibration over the travel of the elevator car 120. In other words, the measurement generates data descriptive of the vibration experienced by the elevator car 120 during the entire travel. Due to that the elevator car 120 is accelerated to a constant speed when initiating the travel from a floor and decelerated when approaching to a landing such inputs to the at least one sensor 140 may be filtered out from the measurement data or to arrange that a generation of the measurement data is performed only over the travel at the constant speed. By taking such an approach it may be concluded that the measurement data represents vibration experienced by the elevator car 120 caused by different excitation sources, such as misalignments or shortcuts due to installation accuracy, component malfunctions, worn-out of components and so on. In addition to the measurement of the vibration a position of the elevator car 120 in the shaft is recorded so that the vibration experienced by the elevator car 120 is mapped with a position of the elevator car 120. The position data may be obtained from any known system applied in elevators for generating the positional data of the elevator car 120 in the elevator shaft. For example, it may be based on a determination of the position with a sensor associated to the elevator car 120 and/or to elevator shaft (e.g. switches), or it may be performed on a basis of information obtainable from an encoder configured to generate data descriptive of a rotation of an electric motor of the elevator. Moreover, since the measurement is performed in time domain the measurement values may also be associated with time stamps indicative of an instant of time of a measurement of each value. Now, for preparing the measurement data for the purpose of the present invention a signal processing may be applied in a known manner to the measurement data so as to generate a representation of the vibration in a frequency domain over the time the speed of the elevator car 120 is constant wherein the position of the elevator car 120 is known at each instant of time over the time the speed of the elevator car 120 is constant. The signal processing may be performed by one or more computing units 160 of the computing system 150 which computing unit 160 is provided with an access to all measurement data as described. The access may be provided so that the measurement data, and any other data, is delivered to the computing unit 160 from the elevator system 110, e.g. through the elevator controller 130 either as a raw data, or pre-processed in any manner, or the data is continuously stored in data storage 170 to which the computing unit 160, or computing units 160, involved in the data processing is provided with the access.

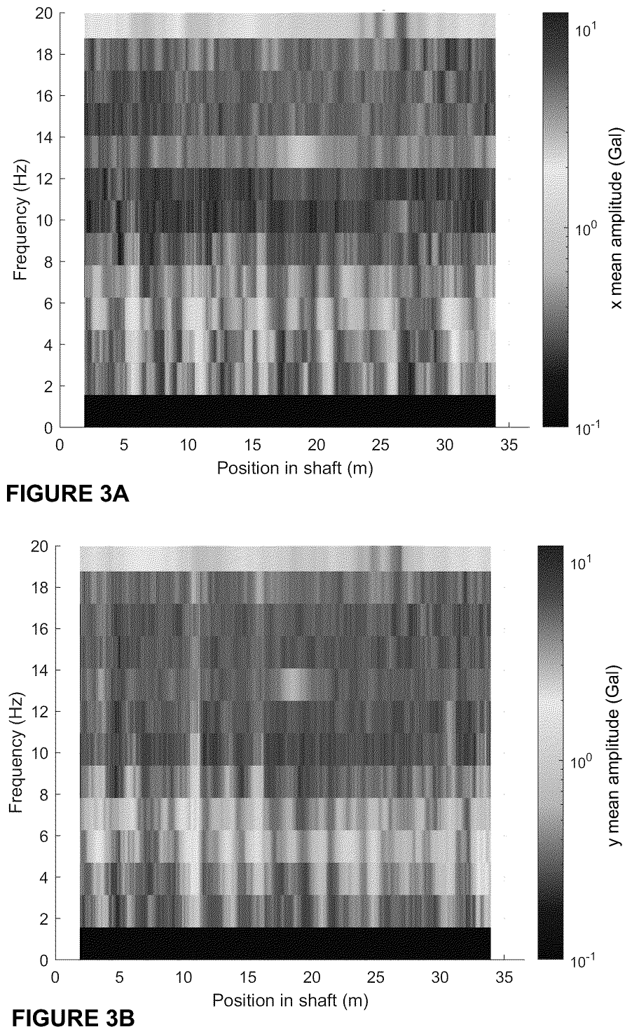

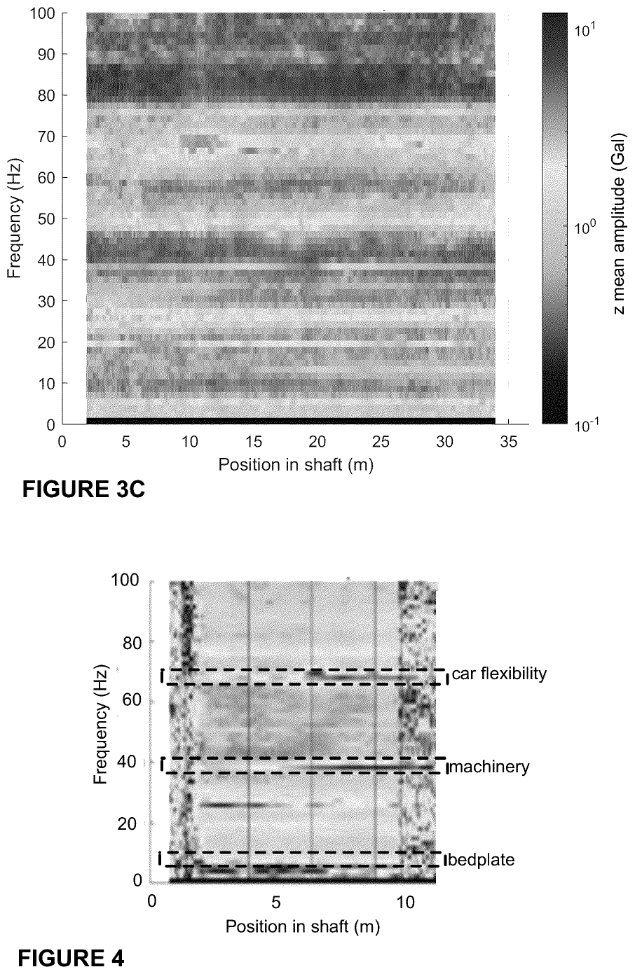

It is now assumed that the collection of the measurement data is performed in a manner that the vibrational data with respect to a position of the elevator car 120 is received by the computing unit 160 and further aspects are now discussed by referring to FIG. 2 schematically illustrating at least some steps of a method according to the present invention. As mentioned in the foregoing description the computing unit 160 is configured to perform signal processing so that a representation in a frequency is generated 210 so that the generated representation is descriptive of a vibration experienced by the elevator car 120 during the travel of the elevator car 120, especially when the elevator car 120 is travelling at a constant speed. In accordance with the present invention the representation in the frequency domain is a spectrogram which is a visual representation of the spectrum of frequencies of the signal as it varies with respect to reference parameter, such as with time or with position. The representation may be generated by applying an applicable mathematical algorithm to the measurement data, such as a Fast Fourier Transformation (FFT) algorithm, which generates a representation illustrating the variation of the vibration in time. An example of a spectrograms generated in the manner as described are shown in FIGS. 3A-3C disclosing vibrations in various dimensions (X, Y, Z) in the 3-dimensional measurement space with respect to a measurement position wherein the measurement position corresponds to the time since the measurement data represents the window during which the elevator car 120 travels at a constant speed, and the measurement data as such is collected with respect to the position, or at least the vibration values may be associated to a position of the elevator car 120 in its travel path based on time information. As said, each of FIGS. 3A-3C illustrates the vibration experienced by the elevator car 120 to one direction in the 3-dimensional space for the same travel of the elevator car 120 (downwards) which are possible to generate based on data generated by the sensors in use. The spectrogram also comprises a further dimension since the intensity of the colors in the spectrogram images represent an amplitude of a particular frequency at the respective position and such a scale for evaluating the amplitude is illustrated in FIGS. 3A-3C (the pane on the right in FIGS. 3A-3C).

In response to a generation of the representation as described, i.e. the spectrogram, the computing unit 160 may be configured to determine 220 if the representation comprises one or more portions corresponding to reference data. The reference data defines a number of vibrational fingerprints each of which are representations descriptive of a vibration generable by an entity of an elevator system. In other words, the vibrational fingerprints may be understood as accurate representation of a vibration of a certain entity, such as a component, of an elevator system. Typically, the vibrational fingerprint is a sub-section of any representation against which the determination may be made. Hence, the determination 220 may be understood as a computer-implemented process in which an attempt is to find a corresponding sub-section from the representation in the frequency domain descriptive of the vibration experienced by the elevator car 120 during the travel of the elevator car 120 as is defined by a number of vibrational fingerprints forming the reference data. For sake of clarity it is worthwhile to mention that the reference data may be generated in a manner as is described in the forthcoming description so that it comprise vibrational fingerprints with respect to the same directions in the 3-dimensional space as the measurement data is generated so as to make the pieces of data comparable so that the determination may be made.

The number of vibrational fingerprints forming the reference data may advantageously be generated by forming a simulation models of a number of elevator systems and simulating an operation of the respective elevator systems, and entities of the elevator systems, so that the reference data may be formed. Furthermore, it is possible to utilize so-called history data obtained from a number of elevator systems operating in various locations and therefrom form the vibrational fingerprints. The forming of the reference data may be performed so that the representations in the frequency domain are formed from the data descriptive of the operation of the elevator system obtained either from the simulation or from the history data. Now, portions of the generated representation may be obtained, or extracted, therefrom to generate the vibrational fingerprints to form the reference data to be used in the method in accordance with the present invention. The portions may be obtained from the representation by extracting known portions from the representation which describe portions generated by known entities of the elevator system at least in terms of a frequency. For sake of clarity, the frequency, or frequencies, and their amplitudes may be used as a definition of the vibrational fingerprint due to that the entities generate an output to the representation, which is characteristic to the respective entities. The frequency aspect may be called as an eigenfrequency of the respective entity, but as said the amplitude aspect may also be taken into account. Such aspects are schematically illustrated in FIG. 4 in which it is shown how frequency ranges may be extracted from the representation to correspond to the entities of the elevator system 110. For example, a certain frequency range, e.g. around 10 Hz, may be known to be generated due to a vibration of a bedplate of a machinery of the elevator system and exhibit as resonance peak (cf. high amplitude) in the spectrogram. Furthermore, another frequency range, e.g. around 40 Hz, may be known to be generated due to an operation of the machinery. Still another frequency range, e.g. around 70 Hz, may be known to be generated due to a flexibility of a structure of the elevator car 120. The frequency ranges caused by the different entities of the elevator system 110 may be known from simulation of the elevator design and entities, such as components therein, and/or from testing of the respective entities, and the elevator system, for example. Correspondingly the size of the range may be defined in the same manner and depending on the entity it may very narrow, or even a certain frequency, whereas it may also be broad with respect to another entity. Still further, it may be determined that a certain vibrational fingerprint occurs at a certain instant of time during the travel, i.e. at a certain position in the shaft e.g. due to that the entity causing the vibration resides in the respective position, and hence, the vibrational fingerprint may be obtained from a certain position of the representation i.e. not over the whole travel path as the examples shown in FIG. 4. The generated vibrational fingerprints may be labeled with an information on the entity, such as on a component, they represent. In other words, the labeling refers to an establishment of information which identify the entity generating the respective vibrational fingerprint. Further labels may also be provided, such as the direction in the 3-dimensional space the vibrational fingerprint represents.

A further note with respect to the generation of the vibrational fingerprints may be that in an automatic generation of the vibrational fingerprints from the representations generated from the simulation data or the history data a predefined algorithm may be applied to the task. The applied algorithm, i.e. the mathematical method, may e.g. be so-called Finite Element (FE) analysis, which may be configured to identify frequency ranges known to be generated by respective entities in the elevator system. In other words, the sources of excitation, i.e. at least some entities of the elevator system, are known to have impact at known frequencies, or at frequency ranges, in the representation and those are identified in order to generate the reference data.

Now, by reverting back to FIG. 2 and the description of the method in accordance with an example embodiment of the invention the determination step may generate, as an outcome of the determination 220, a detection result to express one of the following: i) an entity corresponding to a vibrational fingerprint of the reference data is present in the elevator system, ii) an entity corresponding to a vibrational fingerprint of the reference data is absent in the elevator system. In other words, a detection result may be set to indicate if the elevator system 110 from which the measurement data is obtained comprises at least one entity defined by the number of vibrational fingerprints or not. In other words, the method may be considered to generate a classification of entities detected from the elevator system 110. Thus, in case a detection result is made of at least one entity, it may be arranged that an indication is made to a data record to indicate that the elevator system in question comprises an entity detected through the analysis. In other words, the indication may be stored in a memory either locally or to a remote data storage wherein the data record may represent a definition for the elevator system 110 in question wherein the stored data may define the entities detected from the elevator system 110 in the manner as described. Further data may also be associated to the indication, such as a time stamp of the measurement and/or the analysis, the portion, i.e. the sub-section, of the representation based on which the detection result is made, and so on.

In accordance with some example embodiments of the invention the method performed by the computing unit may further comprise a step in which data record associating the entity detected to be present in the elevator system 110 with data indicative of a position of the respective entity is generated. This may correspond to a process in which the entity causing the positive detection result is defined on the basis of the vibrational fingerprint corresponding to the entity and additionally the data indicative of the position in a travel path of the elevator car may be determined from the representation, e.g. by mapping the detected fingerprint to the representation and obtaining therefrom the data indicative of the position in the shaft. The data indicative of the position of the respective entity may also be expressed in terms of time if applicable since the correspondence between the time and the position in the shaft is obtainable from the measurement data, for example. In response to the generation of the data record it may be stored to data storage (170).

The method as described may be a computer-implemented method and preferably in accordance with the present invention it is at least in part implemented by utilizing a machine-learning model in the task. The machine-learning model, ML, may be used in performing the determination 220 e.g. as a predefined type of comparison process as well as in a generation of the output of the determination by setting 230 the detection result as described. This may be arranged by training the machine-learning model with a training data formed from the simulation data and/or from the history data so that the machine-learning model becomes capable of setting 230 the detection result to indicate if at least one entity defined by the training data may be determined from an elevator system based on an analysis of the representation in the frequency domain generated from the measurement data. Hence, it may be considered that the machine-learning model may classify the detections in accordance with the detected entities from the measurement data since the detection brings out the entity causing the detection since the vibrational fingerprints are labeled at least with the entity information wherefrom the entity information may be obtained for the detection of the entity from the representation generated from the measurement data.

For sake of completeness, it is worthwhile to mention that the training data may represent any type of an elevator system, but in order to train the machine-learning model efficiently to perform detections towards a certain type of elevator systems, it may be advantageous to arrange that the training dataset is formed based respective elevator systems, or at least close to, as those analyzed by the machine-learning model.

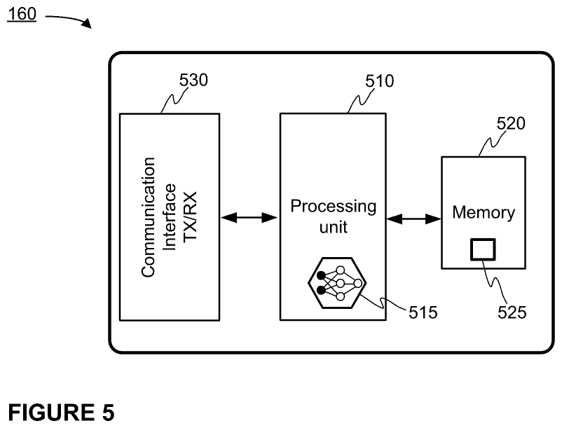

An example of an apparatus suitable for performing a method according to an example embodiment of the invention as the computing unit 160 is schematically illustrated in FIG. 5 as a block diagram. The apparatus may be configured to implement at least part of the method for generating data for the data record.

The execution of the method, or at least some portions of it, may be achieved by arranging a processing unit 510 comprising at least one processor to execute at least some portion of computer program code 525 stored in at least one memory 520 causing the processor 510, and, thus, the apparatus to implement the method steps as described. In other words, the processing unit 510 may be arranged to access the memory 520 and to retrieve and to store any information therefrom and thereto. Moreover, the processing unit 510 may be configured to control a communication through one or more communication interfaces 530 for accessing the other entities being involved in the operation, such as the data storage 170 in a manner as described in the foregoing description. Hence, the communication interface 530 may be arranged to implement, possibly under control of the processing unit 510, a number of communication protocols, such as an IP or any other communication protocol, for communicating with one or more entities to receive input and to output data as described. The term communication interface 530 shall be understood in a broad manner comprising necessary hardware and software elements for implementing the communication techniques. Further, the apparatus in question comprises one or more input/output devices for inputting and outputting information. In accordance with the present invention such input/output devices forming a user interface may at least comprise a touch screen, but may also comprise further entities, such as a physical keyboard, buttons, display, loudspeaker, microphone camera and so on. In some implementation of the apparatus at least some of the input/output devices may be external to the apparatus and coupled to it either wirelessly or in a wired manner. For sake of clarity, the processing unit 510 herein refers to any unit or a plurality of units suitable for processing information and control the operation of the apparatus in general at least in part, among other tasks. The mentioned operations may e.g. be implemented with a microcontroller solution with embedded software. Similarly, the invention is not limited to a certain type of memory 520, but any memory unit or a plurality of memory units suitable for storing the described pieces of information, such as portions of computer program code and/or parameters, may be applied in the context of the present invention. Moreover, at least the mentioned entities may be arranged to be at least communicatively coupled to each other with an internal data connection, such as with a data bus.

In FIG. 5 it is also schematically illustrated a machine-learning model 515 executable with the main processing unit 510 or with a dedicated processing unit. The machine learning model 515 may represent the model being used for processing the measurement data in accordance with the present invention. The machine-learning model 515 may be prepared for the task by training it with a history data and or with data generated by simulating an operation of the elevator system. The learning may involve learning of multiple layers of nonlinear processing units, either in supervised or in unsupervised manner. These layers form a hierarchy of layers, which may be referred to as artificial neural network. Each learned layer extracts feature representations from the input data, where features from lower layers represent low-level semantics (i.e. more abstract concepts). Generally speaking, deep learning techniques allow for recognizing and detecting objects in images with great accuracy, outperforming previous methods. As such the definitions of the machine-learning model 515 in a computer language may be stored in the memory 520, or in any other data storage accessible by the processing unit 510 e.g. over the communication interface 530, and the processing unit 510 may access the data and execute the machine-learning model in a necessary manner.

Hence, the computing unit 160 as schematically illustrated in FIG. 5 is configured to receive the measurement data, to process it in the manner as described in the foregoing description, and to perform the method with a help of the trained machine-learning model 515 in a manner as described.

In some examples, the computing unit 160 may be implemented with a distributed computing environment in which a plurality of computing devices is configured to cooperate to cause an execution of the method according to at least one of the examples as described. A non-limiting example of such a distributed computing system may be that a first computing unit 160 is configured to collect the measurement data and e.g. to pre-process it for inputting it to a second computing unit 160. The pre-processing may e.g. comprise a step in which the representation in the frequency domain is generated. The second computing unit 160, in turn, may be configured to perform an extraction of the at least one portion of data from the representation in accordance with a predefined set of rules and e.g. classify them in accordance with the entity identified to generate the respective portions of data in the representation. Finally, the second computing unit 160 may output the portions of the data to a data record.

As derivable from above, some aspects of the present invention may relate to a computer program product which, when executed by at least one processor, cause an apparatus as the computing unit 160 to perform at least some portions of the method as described. For example, the computer program product may comprise at least one computer-readable non-transitory medium having the computer program code 525 stored thereon. The computer-readable non-transitory medium may comprise a memory device or a record medium such as a CD-ROM, a DVD, a Blu-ray disc, or another article of manufacture that tangibly embodies the computer program. As another example, the computer program may be provided as a signal configured to reliably transfer the computer program.

Still further, the computer program code 525 may comprise a proprietary application, such as computer program code for generating the data record in the manner as described.

The computer program code 525 may also be considered to include the definitions and instructions of an execution of the application of the data record in a further use.

For sake of completeness it is worthwhile to mention that the machine learning model applicable to be used for the processing of the data in the described manner may e.g. be a convolutional neural network, CNN, but also other types of neural networks may also be used for.

Still further, the foregoing description provides that the vibrational fingerprints and the spectrogram are digital images, and they are used as such in the comparison. As is known the digital images are images composed of picture elements, also known as pixels, each with finite, discrete quantities of numeric representation, or values, e.g. for its intensity or gray level. Hence, the comparison is made between one or more of these values in any known manner in order to decide their likeliness with an acceptable accuracy.

The specific examples provided in the description given above should not be construed as limiting the applicability and/or the interpretation of the appended claims. Lists and groups of examples provided in the description given above are not exhaustive unless otherwise explicitly stated.

1. A computer-implemented method for detecting an entity of an elevator system based on data in a representation generated from measurement data gathered over a travel of an elevator car, the method comprising:
generating the representation in a frequency domain descriptive of a vibration experienced by the elevator car during the travel of the elevator car;
determining if the representation comprises a number of portions corresponding to reference data, the reference data defining a number of vibrational fingerprints generable by a number of entities of the elevator system; and
setting, in accordance with a determination, a detection result to express one of the following:
i) an entity corresponding to a vibrational fingerprint of the reference data is present in the elevator system; and
ii) an entity corresponding to a vibrational fingerprint of the reference data is absent in the elevator system.

2. The computer-implemented method of claim 1, wherein the number of vibrational fingerprints of the reference data are formed in at least one of the following manner:
by simulating an operation of a number of elevator systems; and
by identifying the number of vibrational fingerprints of the reference data from representations in a frequency domain generated from history data collected from a number of elevator systems.

3. The computer-implemented method of claim 1, wherein the determining if the representation comprises the number of portions corresponding to the reference data is performed on a basis of a frequency range and amplitude values of frequencies in the frequency range.

4. The computer-implemented method of claim 1, wherein the generation of the representation in the frequency domain is performed based on the measurement data descriptive of a travel of an elevator car at a constant speed.

5. The computer-implemented method of claim 1, wherein the measurement data is received from at least one sensor configured to measure vibration experienced by the elevator car.

6. The computer-implemented method of claim 1, wherein the representation in the frequency domain is generated in a form of spectrogram.

7. The computer-implemented method of claim 1, the method further comprises:
generating data record associating the entity detected to be present in the elevator system with data indicative of a position of the respective entity; and
storing the data record to data storage.

8. The computer-implemented method of claim 1, wherein at least the determining if the representation comprises the number of portions corresponding to reference data is performed with a machine-learning model, the machine-learning model being trained with the reference data to perform the determining.

9. An apparatus for detecting an entity of an elevator system based on data in a representation generated from measurement data gathered over a travel of an elevator car, the apparatus configured to:
generate the representation in a frequency domain descriptive of a vibration experienced by the elevator car during the travel of the elevator car;
determine if the representation comprises a number of portions corresponding to reference data, the reference data defining a number of vibrational fingerprints generable by a number of entities of the elevator system; and
set, in accordance with a determination, a detection result to express one of the following:
i) an entity corresponding to a vibrational fingerprint of the reference data is present in the elevator system; and
ii) an entity corresponding to a vibrational fingerprint of the reference data is absent in the elevator system.

10. The apparatus of claim 9, wherein the apparatus configured to form the number of vibrational fingerprints of the reference data in at least one of the following manner:
by simulating an operation of a number of elevator systems; and
by identifying the number of vibrational fingerprints of the reference data from representations in a frequency domain generated from history data collected from a number of elevator systems.

11. The apparatus of claim 9, wherein the apparatus is configured to perform the determining if the representation comprises the number of portions corresponding to the reference data on a basis of a frequency range and amplitude values of frequencies in the frequency range.

12. The apparatus of claim 9, wherein the apparatus is configured to perform the generation of the representation in the frequency domain based on the measurement data descriptive of a travel of an elevator car at a constant speed.

13. The apparatus of claim 9, wherein the apparatus is configured to receive the measurement data from at least one sensor configured to measure vibration experienced by the elevator car.

14. The apparatus of claim 9, wherein the apparatus is configured to generate the representation in the frequency domain in a form of spectrogram.

15. The apparatus of claim 9, the apparatus further configured to:
generate data record associating the entity detected to be present in the elevator system with data indicative of a position of the respective entity; and
store the data record to data storage.

16. The apparatus of claim 9, wherein the apparatus is configured to perform at least the determining if the representation comprises the number of portions corresponding to reference data with a machine-learning model, the machine-learning model being trained with the reference data to perform the determining.

17. The apparatus of claim 9, wherein the apparatus is implemented with one or more computing devices.

18. A computer program embodied on a non-transitory computer readable medium and comprising computer readable program code configured to cause performing of the method according to claim 1 when the computer readable program code is run on one or more computing apparatuses.

19. A system comprising an elevator system and a computing system communicatively connected to each other,
wherein the computing system comprises the apparatus according to claim 9.

20. The system of claim 19, wherein the elevator system comprises at least one sensor configured to generate measurement data descriptive of a vibration of an elevator car experienced during a travel of the elevator car.
